(19) United States
(12) Patent Application Publication
(10) Pub. No.: US 2009/0286569 A1
(43) Pub. Date: Nov. 19, 2009

(54) Apparatus method and computer program for interference reduction

(75) Inventors: Seppo O. Rousu, Oulu (FI); Marko E. Leinonen, Haukipudas (FI); Juha P. Valtanen, Oulu (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/154,100

(22) Filed: May 19, 2008

(51) Int. Cl. H04M 1/00

(52) U.S. Cl. 455/553.1

(57) ABSTRACT

A circuit includes a radiofrequency circuit component, a diplexer, a termination, and a further component. The diplexer includes a common port configured to receive an input from the radiofrequency circuit component, a first output port, and a second output port. The termination is configured to receive an input from the first output port of the diplexer. The further component is configured to receive a radiofrequency signal input from the second output port of the diplexer. The circuit may be adapted for a multi-radio device and have a control input for varying a frequency split between the first and second output port according to a radio use case of radios in simultaneous operation.

### CROSS REFERENCE TO RELATED APPLICATIONS

This application is related to co-owned U.S. patent application docket NC60379US/854.0073.U1(US) filed under express mailing label no. EM026579370US and entitled “Apparatus, Method and Computer Program for Configurable Radio-Frequency Front End Filtering”; and also to co-owned U.S. patent application docket NC60220US/854.0061.U1 (US) filed under express mailing label no. EM02657366US and entitled: “Apparatus, Method and Computer Program for Radio-Frequency Path Selection and Tuning”, both of which are filed this same day and both of which are herein incorporated by reference in their entirety.

### TECHNICAL FIELD

The teachings herein relate generally to wireless radio devices and particularly relate to circuitry and methods for reducing interference. Such interference reduction is especially useful when the wireless radio device is a multiradio device having different radios that communicate at different frequencies.

### BACKGROUND

Following are some acronyms used in the text below and in certain of the figures:
DVB-H digital video broadcasting—handheld
E-UTRAN evolved UTRAN (also known as 3.9 G or long term evolution LTE)
GPS global positioning system (e.g., Glonass, Galileo)
GSM global system for mobile communications
HB high band (frequency, as compared to low band)
HP high pass (frequency)
ISM industrial, science, medical
LB low band (frequency, as compared to high band)
LP low pass (frequency)
LTE long term evolution
UTRAN universal mobile telecommunications system terrestrial radio access network
WCDMA wideband code division multiple access
WLAN wireless local area network
WiMAX worldwide interoperability for microwave access

Use of and research into what is termed multiradio devices is a growing trend in wireless communications. They enable the user to take advantage of increased network coverage at hotspots covered by another radio technology, they enable users to access wide area networks (e.g., traditional cellular) and more localized networks (e.g., Bluetooth with a headset or a personal computer PC) either separately or simultaneously, and in some instances enable the wireless device to act as a mobile router for other traffic. A multiradio device user can then optimize costs by, for example, handing over to a radio technology network in which the user pays a flat rate or reduced rate as compared to other available networks, or use a free/low cost network (e.g., WLAN) to which s/he has access for more voluminous data downloads as opposed to another network that charges on a volume basis for data. Different networks may price differently for voice, data and/or broadcast, and the multiradio device can take advantage of cost arbitrage across these different networks and signal types.

If the radio frequency RF air-interface is generating interferences to the wireless terminal receivers and/or transmitters, then a transceiver communication performance is either degraded or the air-interface connection does not work at all.

There are also co-existence interoperability requirements between cellular and complementary transceivers so that different ones of the radios can be used at the same time. As an example following problems may occur with a multiradio device:
WCDMA LTE band VII (2.6 GHz) transmitter generated noise to ISM (WLAN) band, with current filtering (bulk acoustic wave BAW or surface acoustic wave SAW) technology or alternatively ISM band transmission may cause cross modulation interference to LTE band receiver or ISM band transmission is a blocker for LTE band receiver
GSM/WCDMA/CDMA transmitter harmonics, a wide band noise and an adjacent and an alternative channel power leakage overlaps multiple terrestrial and mobile television channels and channel allocations, GPS band and ISM band allocations at 2.4 GHz and 5 GHz frequency ranges.
Cellular harmonics falling to 2.4 GHz and 5 GHz WLAN and WiMAX 3.4 GHz systems

A generalized view of a prior art radio architecture to reduce harmonic interference is shown at FIG. 1. At block A is an active component, such as a RF power transistor, which amplifies an RF signal from an input source (e.g., radio transmitter) and generates unwanted signals such as harmonics. Block B is a supply voltage isolation block, in which fundamental RF signals are isolated from the DC power supply. Block B also performs some harmonic filtering. Block C is a RF matching network, in which low pass matching may also reject some of the unwanted harmonics. Block D is an additional harmonic trap in which the majority of the unwanted harmonics are filtered or otherwise removed in this prior art architecture.

What is needed in the art is a way to reduce interference between radios of a multiradio device and to interface them to antennas while meeting the technical performance requirements, without expanding the housing size of a handheld wireless multiradio device.

### SUMMARY

In accordance with one embodiment of the invention is a circuit that includes a radiofrequency circuit component, a diplexer, a termination, and a further component. The diplexer includes a common port configured to receive an input from the radiofrequency circuit component, a first output port, and a second output port. The termination is configured to receive an input from the first output port of the diplexer. The further component is configured to receive a radiofrequency signal input from the second output port of the diplexer.

In accordance with another embodiment of the invention is a method that includes inputting a radiofrequency signal to a common port of a diplexer, splitting the radiofrequency signal in the diplexer into first and second frequency-selective signal components, terminating the first frequency-selective signal component at a termination via a first output port of the diplexer, and outputting via a second output port of the diplexer the second frequency-selective signal component to a further component, which in one embodiment may be an antenna port.

In accordance with still another embodiment of the invention is a computer readable memory embodying a program of machine-readable instructions executable by a digital data processor to perform actions directed toward attenuating interference signals in a multi-radio device. In this embodiment the actions include determining a radio use case for a multi-radio device, and from the radio use case, determining a frequency split to attenuate interference signals in a radiofrequency signal that is active for the use case. Further in the method, a control signal is applied to an adjustable diplexer to set a frequency cutoff that imposes the frequency split, a radiofrequency signal is split in the adjustable diplexer into first and second frequency-selective signal components that are separated by the frequency cutoff, the first frequency-selective signal component is terminated via a first output port of the diplexer at a termination, and the second frequency-selective signal component is output via a second output port of the diplexer. In an embodiment this second output port couples to a further component which may be an antenna port or a receiver of a radio.

In accordance with yet another embodiment of the invention is a circuit that includes frequency splitting means for splitting a radio frequency signal into a first frequency-selective signal component and a second frequency-selective signal component, termination means for terminating the first frequency-selective signal component, and conveying means for passing the second frequency-selective signal component to transmitting means or to signal processing means. In a particular embodiment, the frequency splitting means may be implemented as a diplexer and the radio frequency signal is received from one of a power amplifier, a modulator, a filtering component, a switch, a balun, a circulator and a modulator; the termination means is a non-reflective load impedance implemented as at least one of a resistive impedance, a shorted transmission line, and an input for power detection circuitry; and the conveying means is a signal propagation branch that couples an output port of the diplexer to the transmitting means which is implemented as a transmit antenna of a multi-radio device or to the signal processing means which is implemented as a processor that has at least a demodulating function.

These and other aspects are detailed below with particularity.

### BRIEF DESCRIPTION OF THE DRAWINGS

FIG. 1 is a prior art circuit block diagram of a radio architecture for harmonic interference reduction.

FIG. 2a is a schematic circuit block diagram showing an exemplary embodiment of the invention configured for harmonic interference suppression.

FIG. 2b is similar to FIG. 2a showing an additional exemplary embodiment of the invention.

FIG. 2c is similar to FIG. 2a showing an additional exemplary embodiment of the invention.

FIG. 2d is similar to FIG. 2a showing an additional exemplary embodiment of the invention.

FIG. 3 is a schematic diagram of two diplexers in series that show an adaptation of one of the circuit block of FIG. 2a according to another exemplary embodiment of the invention.

FIG. 4 is a simplified schematic diagram of a circuit architecture of a RF front end of a multiradio device for reducing harmonic interference among various radios of that device according to an embodiment of the invention.

FIGS. 5 and 6 are similar to FIG. 4 showing other circuit architecture embodiments of the termination branch aspect of the invention.

FIGS. 7 and 8 are schematic diagrams of a radio front end in two different configurations by which a different pair of the three radios of the multiradio device are simultaneously coupled to the antenna with harmonic interference suppression circuits according to exemplary embodiments of the invention disposed along various circuit pathways.

FIG. 9 is a schematic diagram showing exemplary apparatus in which embodiments of the invention may be disposed.

FIG. 10 is a flow diagram representing process steps or functional circuitry to implement an embodiment of the invention related to the termination aspects.

### DETAILED DESCRIPTION

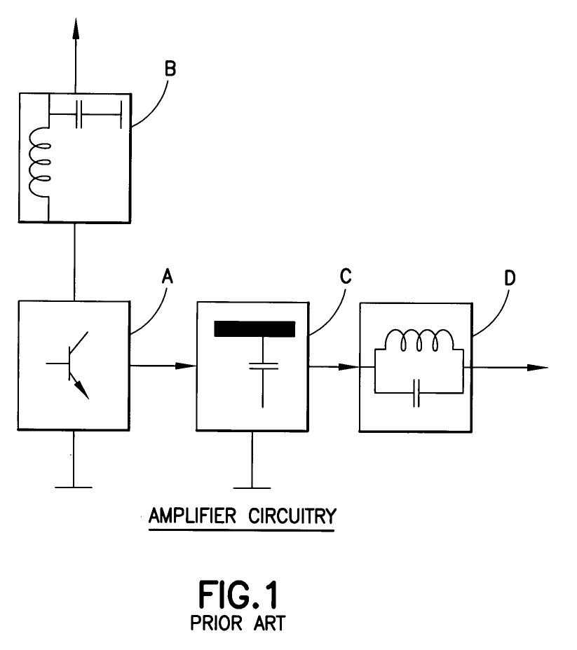

A conventional harmonic rejection trap such as block D of FIG. 1, or a harmonic rejection filter, is fundamentally reflective at harmonic frequencies (low impedance at even harmonics and high impedance at odd harmonics). In many cases this is a desired feature and not a problem. However, there are a few cases in which this may cause some disadvantage. First, electrical components used in a conventional harmonic trap are seldom ideal and thus a reflective load cannot be ensured at the desired harmonic frequencies. Second, a wide operation frequency bandwidth causes even wider harmonic bandwidths, and it is quite a challenge to maintain the desired reflective impedances over a wide frequency spread. Third, the actual termination impedance of a harmonic filter may degrade performance of the filter itself, which would become even more challenging if the termination impedance is a variable impedance like an antenna in a hand held device (e.g., antenna impedance changes due to user interference with the antenna).

One conventional method to overcome the above challenges is to add some additional harmonic filtering (e.g. a shunt capacitor). In a multi-mode multi-band device this may be challenging, because improving harmonic performance in the vicinity of some specific harmonic frequency may degrade performance in some other frequency ranges. Embodiments of the invention address these challenges and are particularly useful in a multi-radio device.

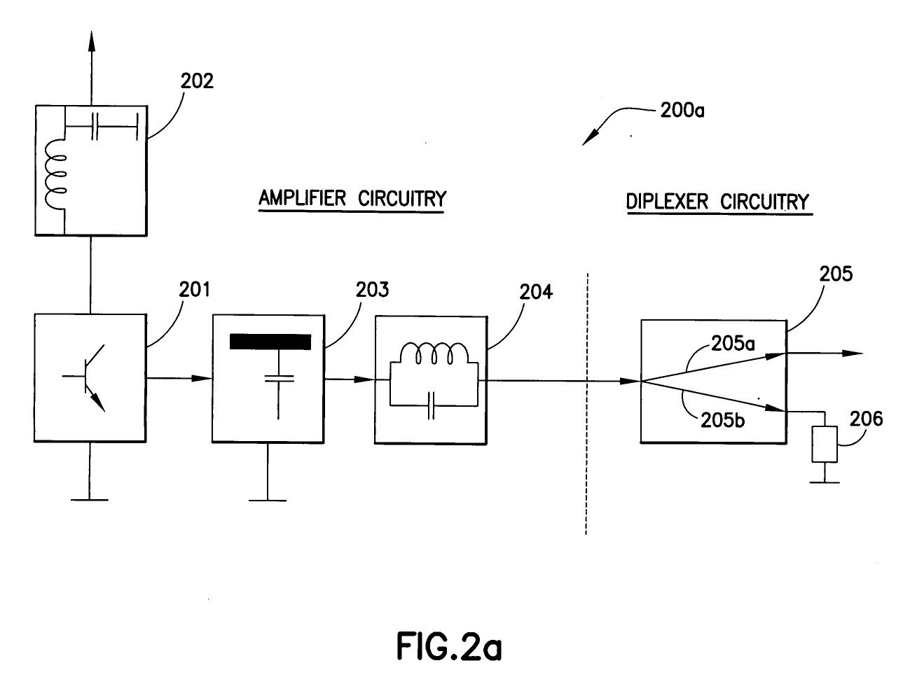

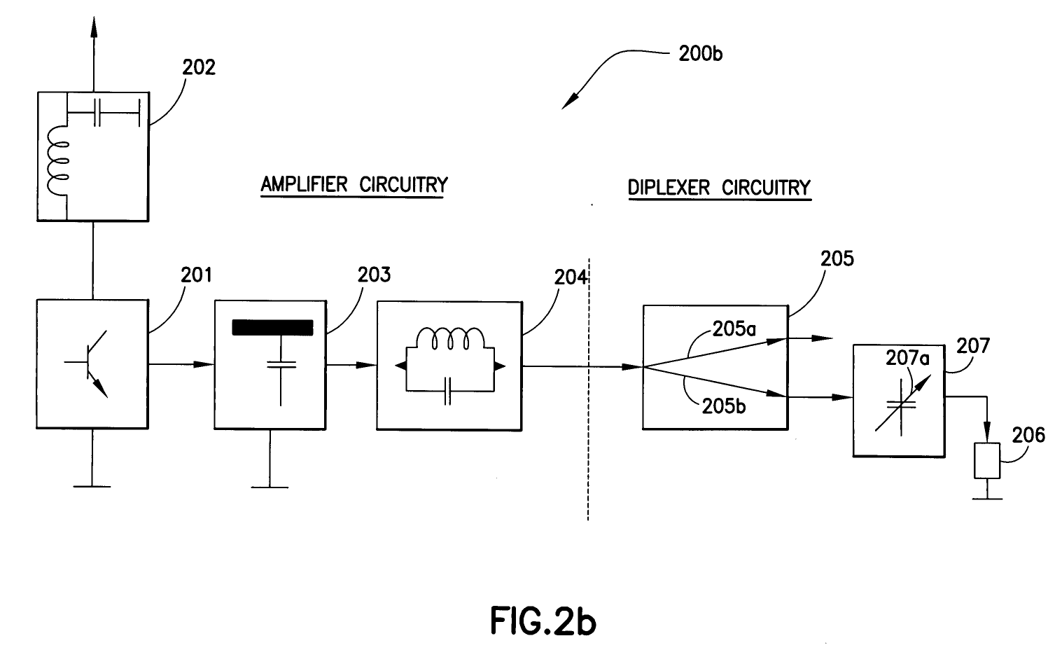

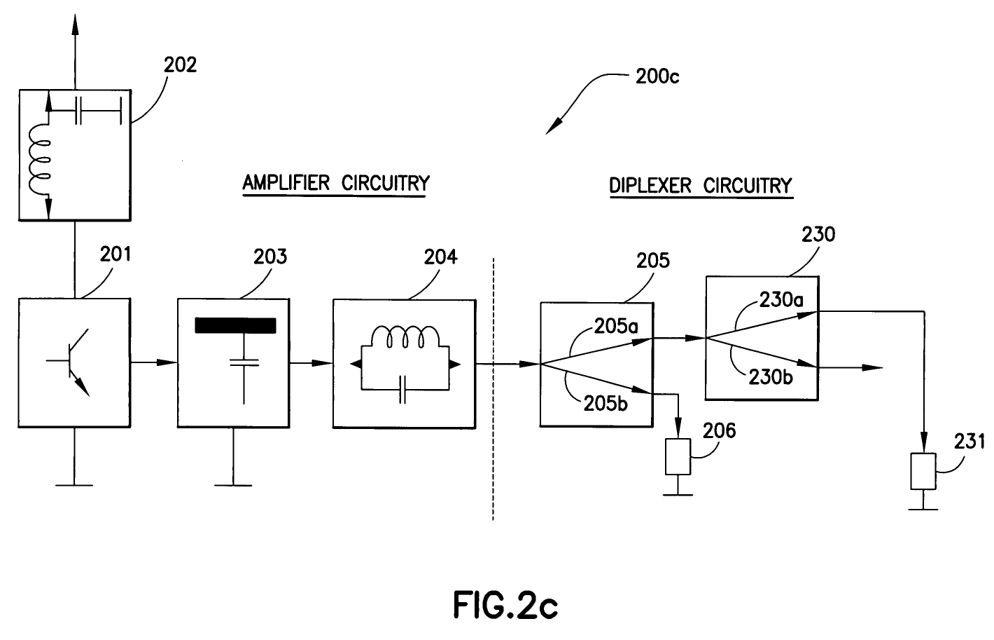

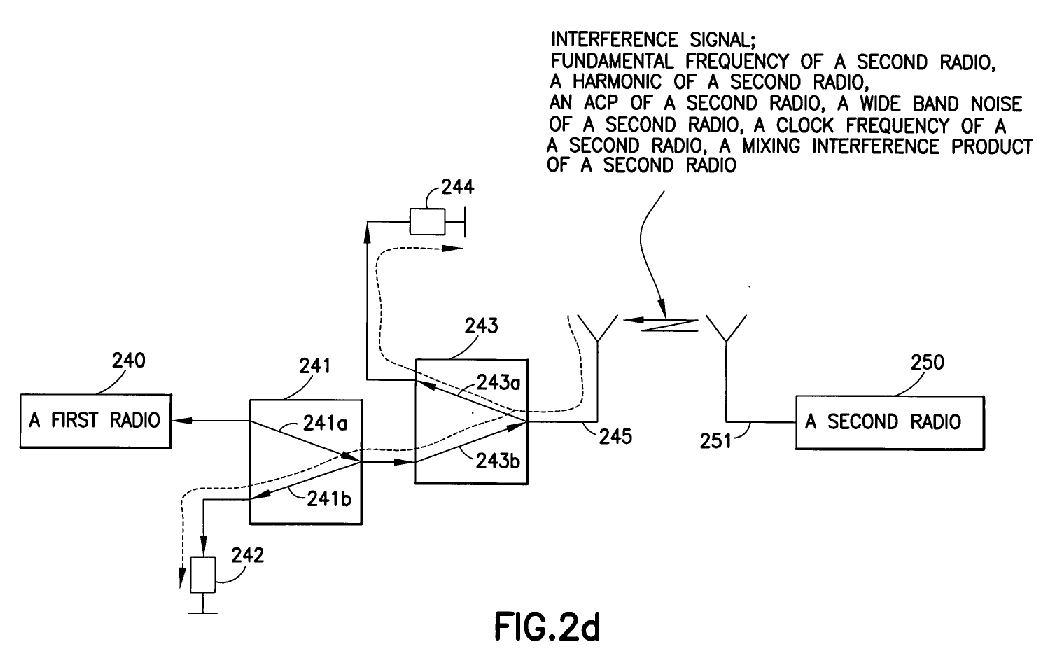

Exemplary embodiments of the invention as shown at FIGS. 2a-2c address the above challenges by a circuit arrangement that provides non-reflective load impedance at harmonic frequencies. Since most conventional harmonic filters are designed at a 50 Ohm condition, it is seen as advantageous to ensure that condition also in cases which would otherwise offer variable un-stable termination impedance.

An exemplary embodiment of the invention is shown in the schematic circuit diagram of FIG. 2a specifically to illustrate distinctions over the prior art architecture of FIG. 1. Block 201 is an active component, such as a RF power transistor, which amplifies an RF signal from an input source (e.g., radio transmitter) and generates unwanted interference signals such as harmonics, a wide band noise or a leakage power outside of a transmission channel. Optional block 202 is a supply voltage isolation block, in which fundamental RF signals are isolated from the DC power supply. Block 202 also performs some harmonic filtering. Block 203 is a RF matching network, in which low pass matching may also reject some of the unwanted harmonics. Optional block 204 is an additional harmonic trap in which the majority of the unwanted harmonics are filtered or otherwise removed in this prior art architecture. Different from FIG. 1, FIG. 2a includes a two-band diplexer 205 at which a signal from the active component 201 is received at a common port. The diplexer 205 has a low pass path 205a that carries the desired signal to a transmit antenna (not shown), and a high pass path 205b that terminates the unwanted interference signals to a resistive load 206 according to an exemplary embodiment of the invention. Note that since the harmonic trap B at FIG. 1 is now redundant to the resistive load/termination 206 of the circuit architecture at FIG. 2a, the harmonic trap 204 may be eliminated from the overall circuit 200. Signal between blocks 201, 202, 203, 204, 205 and 206 are drawn with a single line. It should be noted that signals may be a single-ended or balanced signals. In some applications signals between different blocks may be routed with a different mode and thus a balun, which converts a single-ended signal to balanced signal and vise versa, may be used. Similarly all other signals shown in this application may be either single-ended or balanced signals.

As noted above, the resistive impedance/termination 206 may be fixed at 50 Ohms and is coupled to the high pass output port of the diplexer 205. The antenna and its related port of the RF front end integrated circuit is coupled to the low pass port of the diplexer 206. The signal path from the RF source (e.g., radio transmitter or amplifier) provides the input to the diplexer's common port. The circuit 200a, 200b may impose some extra loss to the signal path due to insertion of the diplexer 206, but the overall system would gain as the harmonics are terminated to a resistive load instead of a reflective (e.g. short or open load) or radiating load (e.g. the antenna itself).

As an alternative embodiment of the invention, instead of the resistive load 206 the high pass port of the diplexer 205 may be terminated by a shorted lamda/4 transmission-line. The length of the shorted transmission line is defined from the source of the last active circuit (e.g. a collector from a power transistor at block 201). This second embodiment offers a low impedance to the even harmonics and a high impedance to the odd harmonics, as seen from the collector of the last active circuit. While a shorted transmission line is known in the prior art to eliminate harmonics from the transmitted signal, to the inventors' knowledge using it in the above manner coupled to the high pass output port of a diplexer 207 is not previously known. Such a shorted transmission line would also make the harmonic trap 204 redundant, and so that trap 204 may be eliminated so as to reduce losses on the signal path.

As an alternative embodiment a sample of the transmission signal to the termination load 206 may be taken to the power detection circuitry. This signal sample may be used as an indicator of the transmission power. The indicator of the transmission power can be used for a transmission power controlling purposes. Alternatively the termination load 206 may be a receiver which is used as a power detection circuitry. Since physical components are not ideal, thus a fundamental attenuated transmission power can be detected from port which is connected to the termination load. The power detection circuitry can decide which signal component an interference signal or a transmission signal is detected. This detected signal power can be used when filtering adjustments are done in a transmitter or in a receiver. This detected signal power, either a transmission signal or an interference signal, can be used when a cutoff frequency of a tunable diplexer is determined and adjusted. The detected signal levels with information of a transmission power control can be stored in a memory of a device for example as a look-up table. The look-up table can be stored in a memory of a device during a manufacturing phase of a device or an updating can be done during an operation of a transmitter. This way transmission power and expected interference level can be estimated prior the transmission and a filtering in a transmitter or in a receiver can be adjusted accordingly.

As an alternative embodiment of the invention FIG. 2a the diplexer 205 has a high pass path 205b that carries the desired signal to a transmit antenna (not shown), and a low pass path 205a that terminates the unwanted interference signals to a resistive load 206 according to an exemplary embodiment of the invention.

FIG. 2b is similar to FIG. 2a but illustrating another embodiment of the invention. Like reference numbers represent like components of the circuit 200b of FIG. 2b as compared to that of FIG. 2a and will not be repeated, and the harmonic trap 204 is also optional in FIG. 2b. Disposed in FIG. 2b between the high pass path output port of the diplexer 205 and the termination 206 is a matching network 207. Optimum matching for certain known harmonics or other type interference signals, such as those between different radios of a multi-radio device in which the circuit 200b may be disposed, may be terminated optimally since they are pre-determined. In this embodiment the matching circuit 207 may be tunable 207a or adjustable to account for different known harmonics for different radio use cases, such as different pairs of radio transmitters and/or receivers operational at the same time. Alternatively matching circuit 207 may be tuned based on interference signal characteristics such as a frequency of an interference and/or a type of an interference signal (e.g. a harmonic interference or a noise interference), since optimal termination impedance for different types of interferences may vary. The terminating impedance on the high pass branch output from the diplexer 205 can be adjustable or match-able to a specific harmonic or other type interference signal in a way that satisfies the idea of resistive (i.e. non-reflective) matching. The adjustable or tune-able matching circuit(s) 207 can be controlled by a specific controller that has a priori information (e.g. timing information or exact frequency of the harmonic or spurious signal) what should be filtered out for a specific case.

In another embodiment of the invention, the diplexer 205 can be a tunable diplexer, or its function can be implemented by a circulator.

In another embodiment of the invention, the tunable diplexer 205 noted immediately above is controlled by either by a controller that is dedicated to control the front end of the dedicated radio (e.g., the radio system that is generating the harmonics that are supposed to be filtered out or wide band noise is needed to be filtered), or a controller that is dedicated to control co-existence tasks (e.g., harmonics are supposed to interfere with another radio in the same multi-radio device).

In another embodiment of the invention, the circuit 200a, 200b does not need to filter harmonics only. For example, where wide band noise and other spurious signals are present, the diplexer 205 could make the separation between that noise/spurious signals and the desired signal as well as terminating the unwanted harmonics.

FIG. 2c is similar to FIG. 2a but illustrating another embodiment of the invention. Like reference numbers represent like components of the circuit 200c of FIG. 2c as compared to that of FIG. 2a and will not be repeated, and the harmonic trap 204 is also optional in FIG. 2c. An additional diplexer 230 is disposed after diplexer 205. The output port 205a of the diplexer 205 is coupled to a common port of the diplexer 230. A high pass output port 230b may be connected to an antenna port or to other component (not shown in the FIG. 2c). A low pass port 230a is coupled to a termination 231. The termination 231 is used to filter out a low frequency interference of the transmission signal. When two diplexers are arranged in series so that a first diplexer 205 filters a high frequency interference and a second diplexer 230 filters a low frequency interference, then a transmission signal is substantially without interference signals for other radios.

Another exemplary embodiment of the invention is shown in the schematic circuit diagram of FIG. 2d. The circuit diagram includes two radios, which may be a receiver, a transmitter or a transceiver or any combination of those. The first radio 240 may be similar transmitter arrangement as described in FIGS. 2a-2c. Alternatively the first radio 240 may be a receiver which is coupled to a diplexer circuitry and to an antenna 245. Two diplexer circuitries 241 and 243 are shown in FIG. 2d. A second radio 250 may be an external radio from a device where the first radio is located. Alternatively the second radio 250 may be another radio located within the device where the first radio is located. The second radio 250 may be similar than described in FIG. 2a-2c. The second radio 250 may interfere the first radio 240 operation with an interfering signal which may be at least one of a fundamental frequency of the second radio, a harmonic of the second radio transmission, a leakage power outside of a transmission channel of the second radio, a wide band noise of a transmission of the second radio, a clock frequency of the second radio or a mixing interference product of a second radio. The mixing interfere product may be generated with as a cross modulation product which may occur when an external interference is propagated to an amplifier which a transmission and mixing of two signal is occurred. A dashed line shows interference signal flow in FIG. 2d. The diplexer 243 conveys high frequency interference to termination impedance 244 and the diplexer 241 conveys low frequency interference to the termination impedance 242. When cut-off frequencies of the diplexers 241 and 243 are selected with a suitable manner external interference will not degrade the operation of the first radio 240. If the first radio 240 is a transmitter, then cross modulation of the first transmitter transmission can be avoided. If the first radio 240 is a receiver, then blocking or filtering characteristics of a receiver can be improved.

In an exemplary embodiment of the invention a sample of a signal to the termination impedances 242 or 244 can be conveyed to a power detection circuitry. Terminations 242 and 244 can be coupled with a receiver 240. A power detection circuitry can operate and the information can be used similar manner as described with the description of FIG. 2a. Detected power or interference signal information from the first radio (e.g. from 242, 244 or 206) can routed to the second radio 250 in order to reduce transmission interference of a second radio. According this information the second radio can adjust a filtering of a transmitter or a receiver the second radio in order to reduce interference to the first radio. Alternately the second radio may alter at least one of a transmission frequency, a transmission band width, a transmission modulation method, a number of subcarriers of a transmission, change communication method, change used transmission antenna, a transmission power level or a coding of a transmission.

Any of the various embodiments noted above, which may be alone or combined with one another, may be implemented in a mobile device with one or more main radios (e.g. several GSM and/or WCDMA frequency bands) or in a multi-mode multi-band radio device which has one or more radio systems (e.g. cellular radios and/or non-cellular or complementary radios such as Bluetooth, GPS, WLAN and the like).

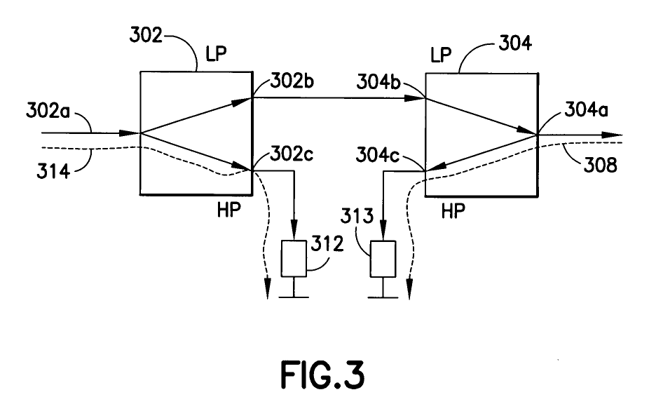

Another implementation is shown at FIG. 3, in which two diplexers are in series with one another between a radio and an antenna to extend the inventive concept to both transmit and receive directions along the same signal pathway. At FIG. 3 a single input signal (e.g., from a modulator 314) is input to a common port 302a of a first diplexer 302, of which a high pass port 302c is connected to a termination 312 and a low pass port 302b is connected to a low pass port 304b of a second diplexer 304. The high pass port 304c of the second diplexer 304 is connected to another termination load 313, and the common port 304a of the second diplexer is connected to an input port of the next component (e.g., a power amplifier PA 308) toward the antenna. The HP corner frequency of the first diplexer 302 is lower than the harmonic signal frequency for the use case. The first diplexer 302 attenuates harmonics in the forward direction (from RF input 314 to PA 308) and the second diplexer 804 attenuates harmonics in the backward direction (from PA 308 to modulator 314) e.g. harmonics are reflected from the next component backward direction. For the embodiment of FIG. 3 with two (or more) diplexers in series, advantages lie in that the first diplexer 302 attenuates harmonics in the forward direction 306 and the second diplexer 304 attenuates harmonics in the backward direction 308.

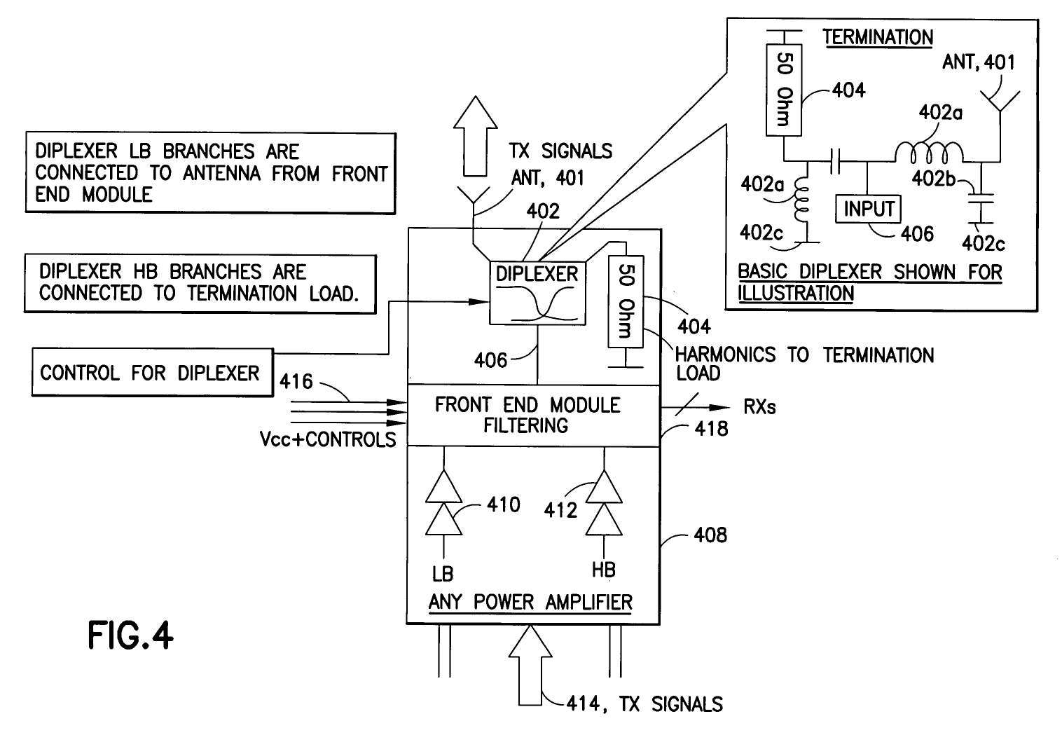

FIG. 4 illustrates another exemplary embodiment of the termination aspects of the invention, and shows select components of a RF front end module of a multi-radio device. The antenna 401 is coupled to a low pass port of a diplexer 402 whose high pass port is coupled to a termination 404. The input 406 to the common port of the diplexer 402 is either the low band LB 410 or the high band HB 412 of transmit signals 414 filtered through a power amplifier 408 and filter module 418. A simple but not limiting diplexer 402 is shown in the inset using conventional symbols for inductors 402a, capacitors 402b and ground 402c. By a control signal 416 to the diplexer 402, the LB branch is connected through the diplexer 402 to the antenna 401 for transmission, and the HB branch is connected to the termination load 404.

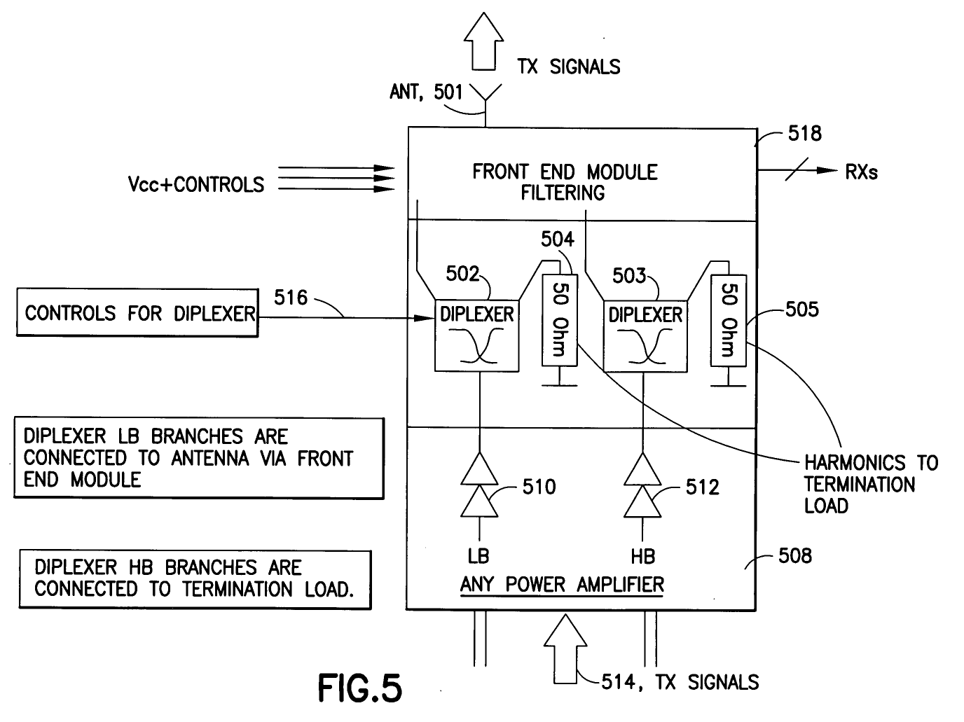

Another exemplary implementation is shown at FIG. 5, which exhibits two notable distinctions over FIG. 4: a second diplexer 503 and termination load 505 are employed in parallel with the first diplexer 502 and termination 504 which are similar to those shown at FIG. 4, and the filtering module 518 lies between the diplexers 502, 503 and the antenna 501. The control signals 516 control both diplexers so that the LP portions of the respective inputs, LB 510 and HB 512, pass to the antenna 501 while the HP portions of those respective inputs are ported to the respective terminations 504, 505. A specific advantage of the embodiment of FIG. 5 is that each PA in the PA module 508 can have its own diplexer structure (two diplexers shown).

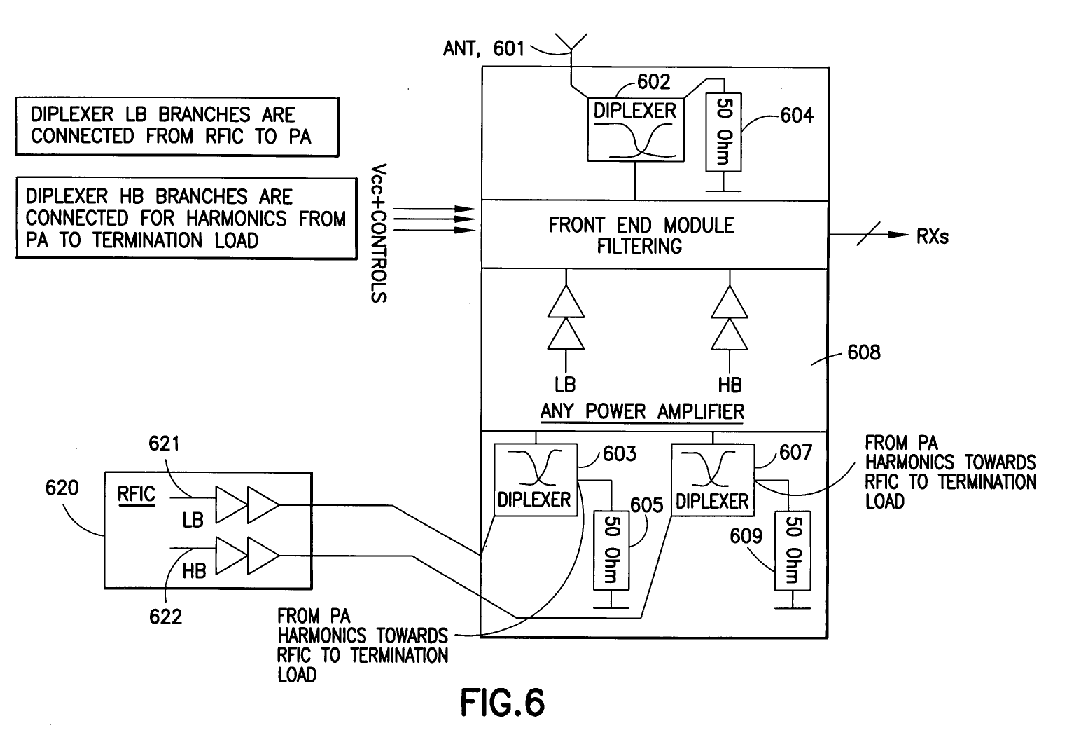

Still another implementation is shown at FIG. 6, which includes a third diplexer 607 and third termination 609. A first diplexer 602 with termination 604 is disposed similar to that shown in FIG. 4, and two further diplexers 603, 607 are disposed in parallel, similar to those of FIG. 5. FIG. 6 includes a RF integrated circuit module 620 which inputs the LB branch 621 and the HP branch 622 into the respective diplexers 603, 607, and each of those diplexers terminate the HP portion of its respective input to its respective termination 605, 609. The LP portion output from those diplexers is then input to the power amplifier PA 608, which is similar as that detailed for FIG. 4. For the embodiment of FIG. 6 an advantage lies in that harmonic leakage and/or a wide band noise from the PA to the RFIC can be attenuated to each modulator.

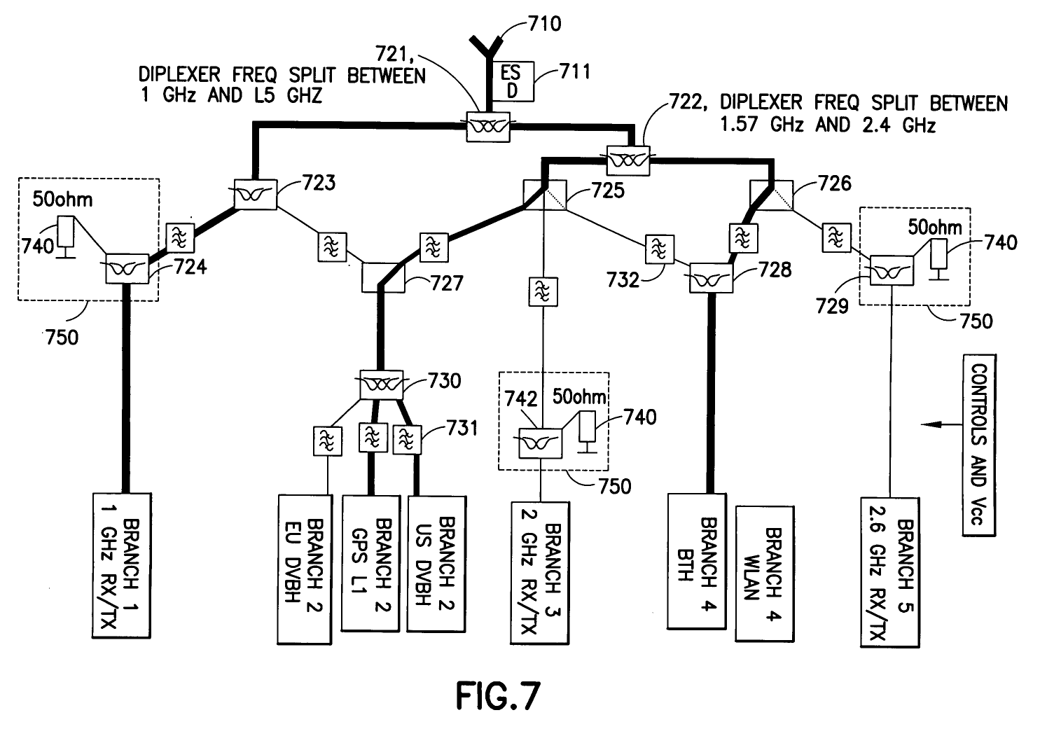

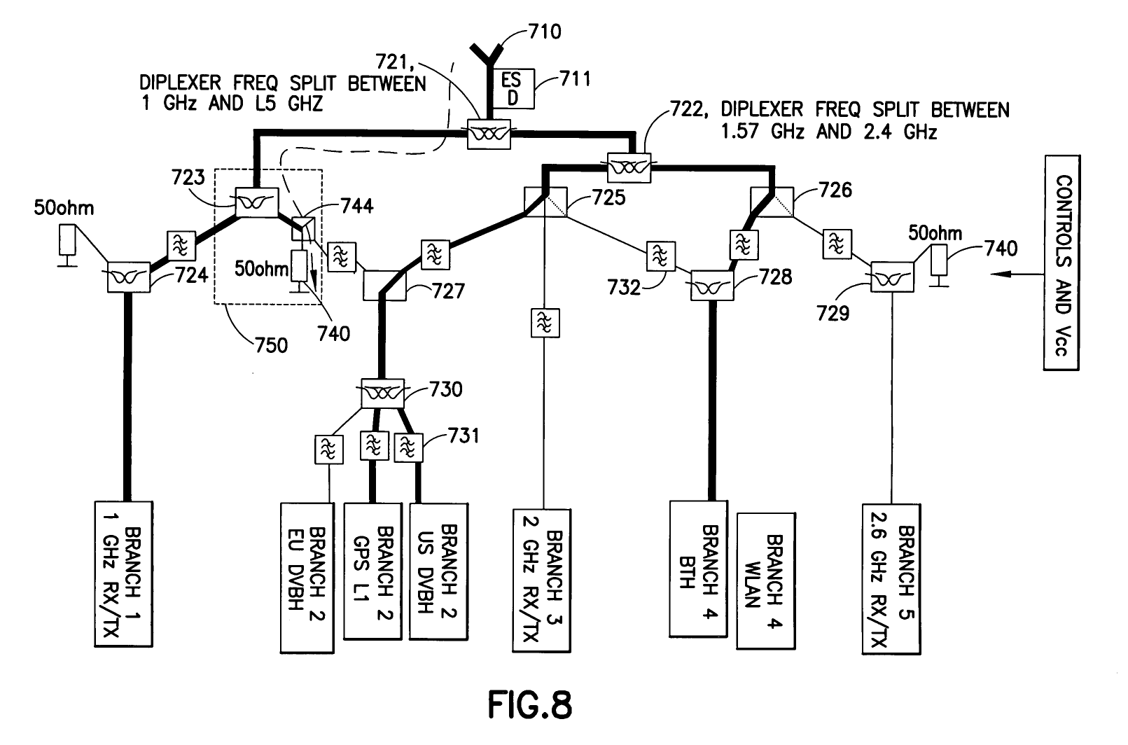

A radiofrequency front end integrated circuit RFIC (an application specific integrated circuit ASIC) arrangement detailed at co-owned U.S. patent application entitled: “Apparatus, Method and Computer Program for Radio-Frequency Path Selection and Tuning” (cross-referenced above) is shown by example for two different use cases at FIGS. 7 and 8, with embodiments of this invention added thereto. Reference numbers across FIGS. 7 and 8 are common to them both. Note that there is a single antenna 710 to which the various radios of the multiradio device (shown only as circuitry in FIGS. 7-8) are selectively coupled. Generally, the radios and antenna are not part of the RFIC, but the RFIC includes corresponding radio ports and one or more antenna ports for coupling to those components. While shown as having only one antenna, a multiradio device embodying this invention may have multiple antennas to exploit diversity transmitting and combining. The RFIC of FIGS. 7-8 selectively couple different combinations of radios to a single illustrated antenna 710, and so may be present in one instance in a device or in multiple instances in a device (e.g., each of two or more antennas of a single device are selectively coupled to different radio combinations according to these teachings). Alternatively individual antennas can be assigned to the radios. The particularized description generally details the invention in the context of transmit pathways in which the radios are transmitters, but these teachings also extend to the companion receive pathways in which the radios are receivers (alternatively or in combination). The term radio/branch as used herein therefore includes transmitters, receivers, and transceivers. Active signal pathways are shown in bold at FIGS. 7-8, and unbolded signal pathways are not active and no RF signal passes over those unbolded pathways.

In FIG. 7, any combination of the radios along branches 1, 2 and 4 can be actively coupled to the antenna 710 at a given time. For example, assume branch 1 couples to a 850 MHz GSM radio (1 GHz), branch 2 couples to a GPS L1 (1.57 GHz) receiver and to a US DVB-H receiver (1.6 GHz), and branch 4 couples to a Bluetooth transceiver and to a WLAN transceiver as illustrated. Since some of these radios are receiver-only, FIG. 7 is described with reference to a received signal. The multiradio antenna 710 may include a tunable for multi frequency functionality. A ESD circuitry 711 may be coupled to the antenna 710. The circuitry 711 may include tunable components for frequency tuning purposes, which may be used antenna tuning purposes. A tunable antenna diplexer is shown at 721; other tunable diplexers 722, 723, 725, 726,727 and 728 are for selecting the active pathways for the various radios according to the active use case, as detailed in the above-referenced application. At the antenna diplexer 721, the input selection of the desired signal is based on interference frequency (frequencies). The antenna diplexer 721 operates in this use case to split frequency between the 1 GHz signal at the left side (the first signal port) and the 1.57 GHz L5 GHz signal (and above for US DVB-H, BT and WLAN) at the right side (the second signal port) of the antenna diplexer 721. This frequency split is set by controls specifically adapted for this use-case, which may be stored in a local memory of the multiradio device and input from a processor over a control lead to the diplexer 721. The processor knows which radios are active and thus can readily determine the use-case at any given time. The diplexer 721 splits the signal from the antenna 721 and outputs a 1 GHz and below cellular signal at its left side, and also attenuates that same clipped signal for cellular harmonics according to this use-case. For the signal output to the left side, the diplexer 721 also operates as a low pass filter, filtering the 1 GHz and below signal to the 850 MHz center frequency of the radio at the end of branch 1. The diplexer 721 similarly operates to high-pass filter the signal from the antenna, outputting a 1.57 GHz and higher signal from the second signal port on its right side for routing to radios along branches 2 and 4 as shown.

Following along the first branch, the signal then passes through diplexer 723, which is tuned to pass a signal based on interference frequency for that use-case. For the FIG. 7 use-case where the 1 GHz cellular radio is connected along branch 1, the diplexer 723 sends the 1 GHz and below frequency signal toward the cellular radio along the bolded branch 1 signal path shown.

Further in FIGS. 7-8 is a diplexer 724 which is termed herein a load balancing diplexer 724 that has a common port going to the cellular 1 GHz radio and a high pass port going to a termination to load 740, shown as a 50 Ohm termination for better antenna matching and interference termination such as cellular harmonics and/or wide band noise. Alternatively a diplexer 724 may have a common port going to the cellular 1 GHZ radio and a low pass port going to a termination to load 740, shown as a 50 Ohm termination for better antenna matching and interference termination such as wide band noise and/or a leakage power outside of a transmission channel. A sample of a transmission power can be detected from a port which is connected to the termination load, which can be routed to the RFIC transmission power controlling purposes.

The various terminations 740 of FIG. 3 are each coupled to the high pass node of the diplexer with which they are associated in the dashed line box 750 to reflect harmonics and/or wide band noise to the termination load 740. While all are given the same reference numbers to avoid confusion, each of the terminations 740 may be a different load from one another so as to be optimized for the specific frequencies it will reflect for the given multiradio use case for the specific radios in simultaneous operation. As seen with the box 750 along branch 3, such a termination 740 may be used in a multiradio branch and associated with a diplexer 742 that is not used to switch circuit paths. FIG. 8 is similar, except instead of the box 750 along branch 3 to offset the inventive circuit, there is a box 750 with a switch 744 and termination 740 coupled to the high pass branch output port of the diplexer 723 that guides interference signals e.g. from a second radio to the termination 740. These terminated interference signals would otherwise interfere with the other active radios on branches 2 or 4 in the use-case of FIG. 8. The switch 744 that may be implemented as a simple switch, a filter or another diplexer.

The radio front end circuitry of FIG. 7 (or of FIG. 8) for a mobile handheld device can be manufactured within a module that is later assembled into the completed device (e.g. low temperature co-fired ceramic LTCC technology) using micro-electro-mechanical systems MEMS capacitors. Such a module may include optionally electrostatic discharge protection, antenna tuning circuits, and/or couplers for total radiated power/total radiated sensitivity TRP/TRS performance optimization (metrics for antenna performance). Such modules may have controls to configure alternate routings and filtering according to the different multiradio use-cases. A controlling unit such as a digital processor or other controller can also be attached to the module, a transceiver, a multiradio controlling unit or baseboard. Control signals themselves may be generated by a microcontrol unit MCU, a digital signal processor DSP, or both. Software algorithms may be employed to use those control signals more efficiently. RF front-end filtering can also be manufactured on a different module. If a multiradio use-case interferences are not limiting its performance, then an optimal route/branch is selected, optimum being in a performance sense (e.g. in TRP, TRS, or power consumption). Also, for a device where one or more radios operate on a time divided transmission system (e.g., a discontinuous reception period or similar concept), the signaling pathways can be configured differently when transmissions are active as compared to when transmissions are not allowed (e.g., sleep mode) for that/those radios.

FIGS. 7-8 are very specific implementations of embodiments of the invention. FIGS. 2-6 show more generalized embodiments not particularly tied to the path-switching circuitry of FIGS. 7-8.

For both FIGS. 7 and 8, implementation may be in a RF front end as detailed above. In FIG. 7 the undesired interference signals e.g. harmonics are guided to the load 740 via diplexer 724 for branch 1 (and also via the other diplexer 729 for branch 5 and via the further diplexer 742 for branch 3), whereas for FIG. 8 the interference signals e.g. from a second radio on branch 1 are guided to the termination 740 via diplexer 723 and switch 744 which allows the radio designer to relax path filter specifications along the receiver path because interference signals e.g. from a second radio (e.g. 2.4 and 5 GHz) transmitters leakage to cellular are attenuated at diplexer 723.

All of the multiradios detailed above can be placed to same main antenna without interoperability problems. Also, the same multiradio front end as described above can be duplicated in the same multiradio device for coupling to a diversity antenna.

Also in FIGS. 7-8 various of the tunable diplexers (which as used herein include more robust variations such as triplexers) used for path switching may be implemented as switches or adjustable Wilkinson dividers or combiners.

The diplexers described herein associated with the termination aspects of the invention may be tunable in that the frequency bands which are passed (and other bands which are blocked) between the common input port and one of the output ports are adaptable by means of control signals sent to the diplex filter. A particular multiradio device will have a certain number of radios, and there will be control signals stored in a local memory which are used to dynamically adapt the cutoff frequency of the different ports of the tunable diplexers described herein based on which particular radios are in use at a given time, which is termed the use-case for the multiradio apparatus. Adaptively changing the cut off frequency of the different diplexfilter ports with control signals based on the use-case enables those control signals to select different active pathways between the antenna and the various radios that are currently in use, and the transmit/receive signals pass along those selected pathways. The use-case is the specific radio or combination of radios that are active (in transmit TX or receive RX mode) at any given time. There are stored control signals for each of the various use-cases that are available for the multiradio, and those control signals are used to control the frequency filtering characteristics of the various diplexers (or to position the switches where switches are used) so as to effectively select the desired active signal pathway(s) for the radio/radios in use. The selected frequency cutoffs are also tailored to avoid interference for the other active TX/RX radio(s) in use for the given use-case. This same use-case knowledge is used with the termination aspects of the invention to optimally terminate the unwanted harmonics to the termination 740 as detailed in the above embodiments.

The following center frequencies are assumed as exemplary for the five-branch multi-radio RFIC of FIGS. 7-8:

| | | |
|---|---|---|
| 1 | GHz: | cellular LOW band; QB GSM/EDGE, WCDMA/E-UTRAN |
| | | (V, VI, VIII, UMTS 700) |
| 1.4 | GHz: | EU L-band DVB-H |
| 1.57 | GHz: | GPS L1, L2 and L5 frequencies |
| 1.6 | GHz: | US DVB-H |
| 2 | GHz: | cellular MID band; GSM, WCDMA/LTE (I, II, III, IV, IX), |
| 2.4 | GHz: | WLAN/BTH |
| 2.6 | GHz: | cellular HIGH band; WCDMA/LTE (VII) |

It is noted that newer technology radios (e.g., upper wideband UWB, WLAN 5 GHz) at higher frequencies are anticipated. Such higher-frequency radios may be connected to same multiradio front end as shown in FIGS. 7-8 or those new radios can have their own antenna, such as for example a printed wiring board antenna.

The specific implementations detailed above attenuate fundamental harmonic interferences via a diplexer structure. Harmonics are guided to the high pass HP branch and wanted frequencies are guided to the low pass LP branch of that diplexer. Such a diplexer can be implemented with discrete components with termination, as a module with an integrated termination or a discrete termination, embedded on low-temperature co-fired ceramic LTCC, as a fixed cutoff frequency between the low pass (LP) and high pass (HP) branches, and/or as a tunable cutoff frequency between the LP and HP branches having control to change cutoff frequency.

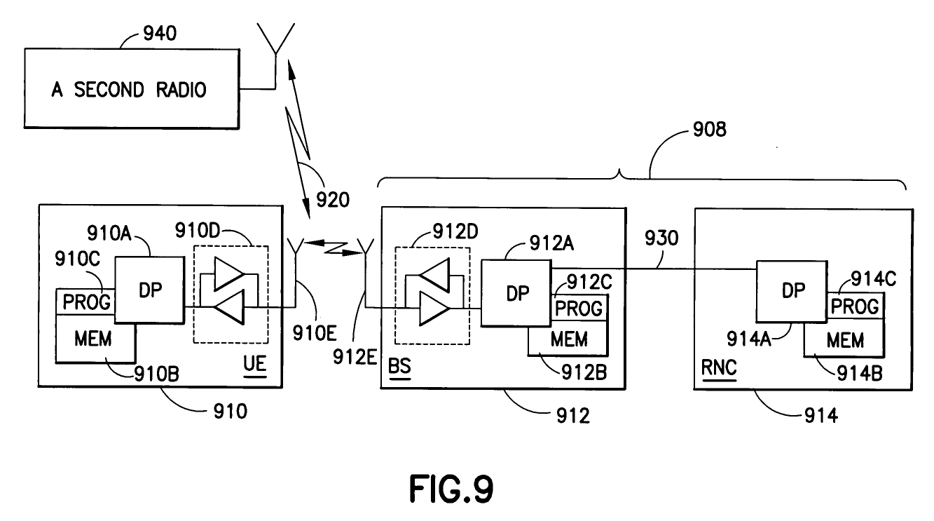

Reference is now made to FIG. 9 for illustrating a simplified block diagram of various electronic devices that are suitable for use in practicing the exemplary embodiments of this invention. In FIG. 9 a wireless network 908 is adapted for communication between a UE 910 and a Node B 912 (e-Node B). The network 908 may include a gateway GW/serving mobility entity MME/radio network controller RNC 914 or other radio controller function known by various terms in different wireless communication systems. The UE 910 includes a data processor (DP) 910A, a memory (MEM) 910B that stores a program (PROG) 910C, and a plurality (one shown) of suitable radio frequency (RF) radios (receivers, transmitters, or transceivers) 910D coupled to one or more antennas 910E (one shown) for bidirectional wireless communications over one or more wireless links 920 with the Node B 912. A second radio device 940 is shown in a FIG. 9. The second radio device 940 may be similar than UE 910.

The term “coupled” means any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The Node B 912 also includes a DP 912A, a MEM 912B, that stores a PROG 912C, and one or more (one shown) suitable RF radios (receivers, transmitters, or transceivers) 912D coupled to one or more antennas 912E (one shown but typically an antenna array). The Node B 912 may be coupled via a data path 930 (e.g., lub or S1 interface) to the serving or other GW/MME/RNC 914. The GW/MME/RNC 914 includes a DP 914A, a MEM 914B that stores a PROG 914C, and a suitable modem and/or transceiver (not shown) for communication with the Node B 912 over the lub link 930.

In one environment, the UE 910 uses its multiradios configured according to an embodiment of this invention to communicate to a plurality of network nodes such as the BS 912 each using one or more different radios, examples of which are detailed above. In another environment, both the UE 910 and the BS 912 communicate with one another using different ones of the multiradios, and both the UE 910 and the BS 912 include an embodiment of this invention. In yet another environment, a single BS 912 according to an embodiment of this invention communicates with different UEs 910 using different ones of its multiradios.

At least one of the PROGs 910C, 912C and possibly 914C (for the case where the data link 930 is wireless and communication between the MME 914 and the BS 912 is via multiradios) is assumed to include program instructions that, when executed by the associated DP, enable the electronic device to operate in accordance with the exemplary embodiments of this invention, as detailed above. Inherent in the DPs 910A, 912A, and 914A is a clock to enable synchronism among the various apparatus for transmissions and receptions within the appropriate time intervals and slots required.

The PROGs 910C, 912C, 914C may be embodied in software, firmware and/or hardware, as is appropriate. In general, the exemplary embodiments of this invention may be implemented by computer software stored in the MEM 910B and executable by the DP 910A of the UE 910 and similar for the other MEM 912B and DP 912A of the Node B 912, or by hardware, or by a combination of software and/or firmware and hardware in any or all of the devices shown.

In general, the various embodiments of the UE 910 can include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, location devices having wireless communication capabilities, music storage and playback appliances having wireless communication capabilities, Internet appliances permitting wireless Internet access and browsing, as well as portable units or terminals that incorporate combinations of such functions.

The MEMs 910B, 912B and 914B may be of any type suitable to the local technical environment and may be implemented using any suitable data storage technology, such as semiconductor-based memory devices, magnetic memory devices and systems, optical memory devices and systems, fixed memory and removable memory. The DPs 910A, 912A and 914A may be of any type suitable to the local technical environment, and may include one or more of general purpose computers, special purpose computers, microprocessors, digital signal processors (DSPs) and processors based on a multi-core processor architecture, as non-limiting examples. Further in this regard it should be noted that the various logical step descriptions below may represent program steps, or interconnected logic circuits, blocks and functions, or a combination of program steps and logic circuits, blocks and functions.

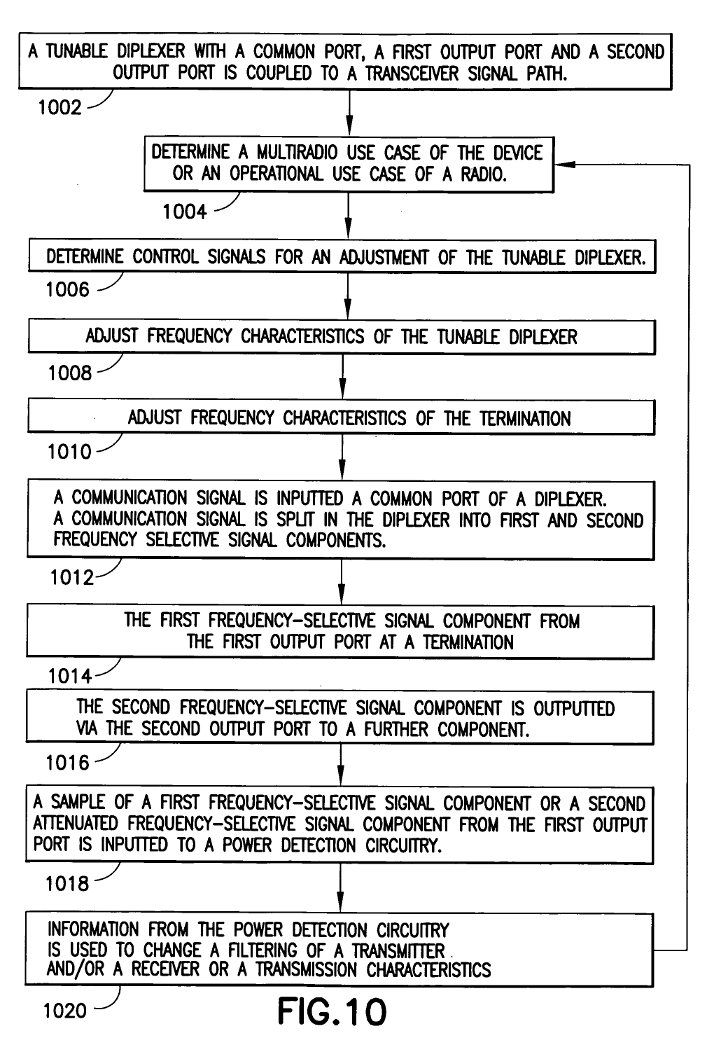

So according to these teachings related to the termination aspects and the related circuitry as seen at FIG. 10 (which may represent process steps or functional circuitry of an integrated circuit for a device), there is provided 1002 a device that includes at least one diplexer (which may be fixed or tunable) that has a common port, a high pass port and a low pass port, and arranged across at least one signal propagation branch that couples a radio to an antenna (signal transmission and/or reception pathways). The multiradio use case of a device or an operational use case of a radio is determined 1004. The multiradio use case of a device or the operational use case of the radio may be determined at least by one or with an any combination of following: An operational frequency of the radio(s), a operational power levels (transmission/reception) of the radio(s), a harmonic operational frequencies and/or powers of the radio(s), a leakage power outside of a transmission channel of the radio(s), a wide band noise frequency and/or a power of the transmission of the radio(s), a timing of a reception and/r transmission of the radio(s). From the use case is determined at block 1006 the control signal(s) to adjust the frequency cutoff(s) of the tunable diplexer, which are applied at block 1008. Also from the use case is determined frequency characteristics to optimize the termination, which is applied at block 1010 since the interference is known in advance from the use case. A communication signal is input (e.g., from a modulator or from the antenna) to the common port (or to the low pass port) of the diplexer and split in that diplexer into first and second frequency selective components at block 1012. The high pass port is coupled to the termination and ports the interference signal (which in this example is the first signal component, e.g. harmonics and/or wide band noise) to the termination at block 1014, and as above a load of the termination is optimized at block 1010 for the interference signal from the radio that would otherwise interfere with another radio coupled to the transmission/reception antenna through another of the plurality of transmission/signal propagation branches, and so the high pass port is adapted 1006 according to the use case 1004. The low pass port (or the common port) couples the signal source to some further component at block 1012. For example, where the input is a receive signal from the antenna, the low pass port couples to a demodulator. Where the input is from a modulator, the low pass port outputs to the antenna. A sample of the first frequency selective signal component is a second attenuated frequency selective signal component from the first input port is input also to power detection circuitry at block 1018, and at block 1020 information from that power detection circuitry is used to change a filtering of the transmitter or receiver or to change transmission characteristics as detailed above. Blocks 1004, 1006, 1008 and 1010 of FIG. 10 are directed to a tunable diplexer, and for implementations of a diplexer which is arranged as described herein and operated without control inputs, the other blocks of FIG. 10 are exemplary. Some blocks of a process described in a FIG. 10 may be omitted or the order of the execution may be changed. Of course the broader aspects of the invention need not be implemented in a multi-radio device and as above the diplexer need not be tunable; FIG. 10 is one particular implementation appropriate for the exemplary multi-radio architecture of FIGS. 4-8.

The fixed or tunable cutoff frequency may be configured a a lower frequency than the unwanted harmonics that are being addressed, and as a tunable diplexer that is optimized according to the specific multiradio use (e.g., 1 GHz or 2 GHz transmitter). The LP branch can be configured to be used by the wanted signal frequencies (e.g., all cellular RX/TX frequencies up to 2170 MHz is routed via the LP branch between the antenna and the transceiver). Then the unwanted higher frequency spuriouses passes the HP branch, which can be terminated to the optimal load for those harmonics. The termination branch can be characterized by a termination load that is fixed for optimal performance (e.g., to 50 Ohm load), adjustable according the multiradio use cases that the multiradio device is designed to address, it can be a filter, and it can be switchable on or off according to the cellular band in use, the current power level and/or according to the specific transmit frequency in current use.

Such embodiments may be most practically implemented in a power amplifier PA or a RFIC component/module. Currently available PAs already include LP filtering for output matching, so a simple implementation would be to add a HP branch to the existing hardware. A fixed diplexer is seen to be adequate for adapting many present RF architectures, though a tunable diplexer is seen to more robust, such as when the LB and HB transmitter paths are done by an adaptive transmitter path as in FIGS. 7-8.

Fundamental frequencies can pass such a diplexer component with modest disadvantage to insertion path loss. Because interference signals such as harmonics are addressed with a termination branch, they do not reflect back from load impedance and do not radiate. This is a flexible implementation for many types of multiradio architecture, since electrical distance from the PA is not critical. Typically filters are based on reflecting frequencies outside of an operational pass band backwards and thus the reflecting phase angle and/or electrical distance between components is important. The diplexer solution provides wideband matching for interfering signals such as harmonics for both amplitude and phase. Typically filters provide narrowband matching, and only one band can be optimal with a fixed filter. Since output port impedance of the diplexer is isolated from an impedance of the output port of the diplexer for termination port, harmonics level altering in the output port of the diplexer, with variable load impedance conditions in the diplexer output port, is reduced by these termination branch teachings.

The antenna load impedance varies for example when a user changes his hand location in proximity to the antenna, or slides a handset between open and closed, or hinges it between open and closed. The termination branch reduces the extent of how the harmonics are altered under those changes. The termination branch embodiments detailed herein relaxes the PA specification, and thus enables better efficiency which means longer talk times in a mobile phone. It also relaxes receiver path filter specification, because interference signals from a transmitter (e.g. cellular transmission harmonics to 2.4 and 5 GHz bands) are attenuated in the diplexer. This also relaxes multiradio interoperability problems due to attenuation for harmonics and/or noise for other radio operational frequencies that these termination teachings provide, and enables more radios to be integrated into one terminal device by increasing filtering for harmonics and/or wideband noise.

Embodiments of the termination aspects of these teachings, coupling the HP path of the diplexer in a multiradio device to a termination, can be embedded in a PA module, a transmit front end module, or a multi-radio front end module. It can be implemented with low cost and low component count. It is noted that pass band insertion loss vs. attenuation is always a trade off as to how and where to tackle interference signals such as wideband noise and harmonics.

It is noted that the harmonic extraction and termination teachings above can be combined into the configurable duplexer circuit 750 (or receive path only portion of it), and also that the configurable duplexer circuit 750 can be implemented along one or more of the branches of the RF front end circuitry detailed above.

In general, the various embodiments may be implemented in hardware or special purpose circuits, software (computer readable instructions embodied on a computer readable medium), logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the invention detailed herein may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope and spirit of the invention as set forth above, or from the scope of the ensuing claims.

We claim:

1. A circuit comprising:
an radiofrequency circuit component;
a diplexer comprising a common port configured to receive an input from the radiofrequency circuit component, a first output port, and a second output port;
a termination configured to receive an input from the first output port of the diplexer; and
a further component configured to receive a radiofrequency signal input from the second output port of the diplexer.

2. The circuit of claim 1, wherein the termination comprises at least one of a non-reflective load impedance, a resistive impedance, a shorted transmission line having length matched to a ground, and an input for power detection circuitry.

3. The circuit of claim 1, wherein the radiofrequency circuit component comprises at least one of a antenna, an active radiofrequency component, a passive radiofrequency component, a power amplifier, a modulator, a filtering component, a switch, a circulator or a balun.

4. The circuit of claim 1, wherein the diplexer is configured to output from the first output port a signal at a higher frequency than a signal output from the second output port.

5. The circuit of claim 1, wherein either:
the radiofrequency component comprises one of a power amplifier and a modulator disposed between a transmitter of a radio and the diplexer common port and the further component comprises an antenna; or
the radio frequency component comprises an antenna and the further component comprises one of a demodulator and a power amplifier.

6. The circuit of claim 1, wherein the diplexer comprises a first diplexer and the termination comprises a first termination, the further component comprising:
a second diplexer having a common port configured to receive an output from the second output port of the first diplexer, a second output port coupled to one of a receiver of a radio and an antenna, and a first output port;
the circuit further comprising a second termination configured to receive an input from the first output port of the second diplexer.

7. The circuit of claim 1, wherein the termination is adjustable, the circuit further comprising a controller configured to apply a control signal to vary an impedance of the termination according to a radio use case of radios in simultaneous operation.

8. The circuit of claim 1, wherein the diplexer is adjustable, the circuit further comprising a controller configured to apply a control signal to vary a frequency split between the first output port and the second output port according to a radio use case of radios in simultaneous operation.

9. The circuit of claim 1 wherein the radio frequency integrated circuit is disposed within a device having a plurality of wireless radios.

10. The circuit of claim 1 in combination with another circuit of claim 1 disposed in parallel along different branches of the radio frequency integrated circuit, the different branches coupling different radios to an antenna.

11. The circuit of claim 1 in combination with another circuit of claim 1 in series with one another between a radio and an antenna and with a power amplifier disposed between the circuits in series with one another.

12. A method comprising:
inputting a radiofrequency signal to a common port of a diplexer;
splitting the radiofrequency signal in the diplexer into first and second frequency-selective signal components;
terminating the first frequency-selective signal component at a termination via a first output port of the diplexer; and
outputting via a second output port of the diplexer the second frequency-selective signal component.

13. The method of claim 12, wherein the first output port comprises an input for a power detection circuitry for inputting a sample of the first frequency-selective signal component or a sample of an attenuated second frequency-selective signal component.

14. The method of claim 12, wherein the termination comprises at least one of a non-reflective load impedance, a resistive impedance, and a shorted transmission line having length matched to a ground.

15. The method of claim 12, wherein the first frequency-selective signal component is a higher frequency than the second frequency-selective signal component.

16. The method of claim 12, wherein one of:
the radiofrequency signal is input to the common port of the diplexer from one of a power amplifier and a modulator disposed between a transmitter of a radio and the diplexer common port and the second frequency-selective signal component is output to one of an antenna or a receiver of a radio.

17. The method of claim 12, wherein the diplexer comprises a first diplexer and the termination comprises a first termination, the method further comprising:
inputting the second radiofrequency signal component to a common port of a second diplexer;
splitting the received second radiofrequency signal component in the second diplexer into a third and fourth frequency-selective signal components;
terminating the third frequency-selective signal component at a second termination via a first output port of the second diplexer; and
outputting via a second output port of the second diplexer the fourth frequency-selective signal component to one of a radio receiver and an antenna.

18. The method of claim 12, further comprising applying a control signal to adjust an impedance of the termination according to a radio use case of radios in simultaneous operation.

19. The method of claim 18, wherein the control signals are generated with reference to a local memory that provides an association between impedance of the termination with radio use case so as to attenuate interference signals in the radiofrequency signal.

20. The method of claim 12, further comprising applying a control signal to vary a frequency split between the first output port and the second output port according to a radio use case of radios in simultaneous operation.

21. The method of claim 20, wherein the control signals are generated with reference to a local memory that provides an association between frequency cutoff of the diplexer that defines the frequency split with radio use case so as to attenuate interference signals in the radiofrequency signal.

22. A computer readable memory embodying a program of machine-readable instructions executable by a digital data processor to perform actions directed toward attenuating interference signals in a multi-radio device, the actions comprising:
determining a radio use case for a multi-radio device;
from the radio use case, determining a frequency split to attenuate interference signals in a radiofrequency signal that is active for the use case;
applying a control signal to an adjustable diplexer to set a frequency cutoff that imposes the frequency split;
splitting a radiofrequency signal in the adjustable diplexer into first and second frequency-selective signal components that are separated by the frequency cutoff;
terminating via a first output port of the diplexer the first frequency-selective signal component at a termination; and
outputting via a second output port of the diplexer the second frequency-selective signal component.

23. The computer readable memory of claim 22, wherein determining the frequency split comprises accessing a local memory with the use case to determine the cutoff frequency.

24. A circuit comprising:
frequency splitting means for splitting a radio frequency signal into a first frequency-selective signal component and a second frequency-selective signal component;
termination means for terminating the first frequency-selective signal component; and
conveying means for passing the second frequency-selective signal component to transmitting means or to signal processing means.

25. The circuit of claim 24, wherein:
the frequency splitting means comprises a diplexer and the radio frequency signal is received from at least one of a power amplifier, a filtering component, a switch, a balun, a circulator and a modulator;
the termination means comprises a non-reflective load impedance implemented as at least one of a resistive impedance, a shorted transmission line and an input for power detection circuitry;
the conveying means comprises a signal propagation branch that couples an output port of the diplexer to the transmitting means that comprises a transmit antenna of a multi-radio device or to the signal processing means that comprises at least a demodulator.
